(19) United States
(12) Patent Application Publication
(10) Pub. No.: US 2006/0254700 A1
(43) Pub. Date: Nov. 16, 2006

(54) MURAL TEMPLATE AND KIT

(76) Inventor: Lawrence Cohen, New Albany, OH (US)

Correspondence Address: MCNEES, WALLACE & NURICK LLC, 100 PINE STREET, P.O. BOX 1166, HARRISBURG, PA, 17108-1166, US

(21) Appl. No.: 11/382,552

(22) Filed: May 10, 2006

Related U.S. Application Data
(60) Provisional application No. 60/679,370, filed on May 10, 2005.

(51) Int. Cl. B44C 1/17; B44C 1/175

(52) U.S. Cl. 156/234; 156/237

(57) ABSTRACT

A method for transferring an image to a substrate is provided. This method includes creating at least one line drawing on a front surface of a two-sided transfer sheet; placing the back surface of the two-sided transfer sheet on or against a substrate; tracing the line drawing on the front surface of the two-sided transfer sheet, wherein tracing the line drawing includes applying pressure to each area of the line drawing being traced, and wherein the applied pressure is sufficient to transfer material from the two-side transfer sheet onto the substrate; and removing the two-sided transfer sheet from the substrate to expose the image traced onto the substrate. The transferred image may be painted or otherwise colored to create a colorful mural having any variety of themes.

### CROSS-REFERENCES TO RELATED APPLICATIONS

This patent application claims the benefit of U.S. Provisional Patent Application Ser. No. 60/679,370 filed on May 10, 2005 and entitled “Transferable Template and Kit”, the disclosure of which is incorporated by reference as if fully rewritten herein.

### BACKGROUND OF THE INVENTION

The present invention relates in general to system and devices for creating two-dimensional images on surfaces, and more specifically to a template for transferring line art to a substrate for the purpose of creating wall, floor, or ceiling art in the form of a mural that may be painted or otherwise colored.

Children, adolescents, and/or parents or other adults often desire to create interesting, colorful and thematic artwork. At times, it may even be desirable to create such artwork on the walls, floors, or ceilings of a home, school, or church. Creating artwork on a wall, floor, ceiling or other substrate surface typically begins with creating a line drawing on the substrate and then filling in the line drawing with ink, chalk, or paint to create a mural. This process may be very time consuming and the results are often highly variable based, at least in part, on the skill and patience of the individuals involved in the process. Thus, there is a need for a template and kit for quickly and easily creating high-quality artwork in the form of wall or floor murals.

### SUMMARY OF THE INVENTION

The following provides a summary of exemplary embodiments of the present invention. This summary is not an extensive overview and is not intended to identify key or critical aspects or elements of the present invention or to delineate its scope.

In accordance with one aspect of the present invention, a system for transferring an image to a substrate is provided. This system includes a substantially flat substrate; a two-sided transfer material having a front side and a back side; at least one image created on the front side of the two-sided transfer material; means for contacting the back side of the two-sided transfer material with the substantially flat substrate; and means for tracing the at least one image on the front side of the two-sided transfer material. The means for tracing the at least one image includes applying pressure to each area of the at least one image being traced, wherein the applied pressure is sufficient to transfer material from the two-side transfer material onto the substantially flat substrate.

In accordance with another aspect of the present invention, a kit for creating an image on a substrate is provided. This kit includes at least one piece of two-sided transfer material, wherein each piece of the two-sided transfer material includes a front surface and a back surface. At least one thematic image has been created on the front side of the transfer material. The kit may include a tracing or outlining pen, paint, brushes, instructions, and numerous other items for facilitating the creation of a mural.

In yet another aspect of this invention, a method for transferring a two-dimensional image to a substrate is provided. This method includes creating at least one line drawing on a front surface of a two-sided transfer sheet; placing the back surface of the two-sided transfer sheet on or against a substrate; tracing the line drawing on the front surface of the two-sided transfer sheet, wherein tracing the line drawing includes applying pressure to each area of the line drawing being traced, and wherein the applied pressure is sufficient to transfer material from the two-side transfer sheet onto the substrate; and removing the two-sided transfer sheet from the substrate to expose the image traced onto the substrate. The transferred image may be painted or otherwise colored to create a colorful mural having any variety of themes.

Additional features and aspects of the present invention will become apparent to those of ordinary skill in the art upon reading and understanding the following detailed description of the exemplary embodiments. As will be appreciated, further embodiments of the invention are possible without departing from the scope and spirit of the invention. Accordingly, the drawings and associated descriptions are to be regarded as illustrative and not restrictive in nature.

### DETAILED DESCRIPTION OF THE INVENTION

Exemplary embodiments of the present invention are now described. Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates to a system, kit, and method for creating a wall, ceiling, or floor mural. A first general embodiment of this invention provides a system for transferring an image to a surface. The system includes a substantially flat substrate; a two-sided transfer material having a front side and a back side; at least one image created on the front side of the two-sided transfer material; adhesive or other means for contacting the back side of the two-sided transfer material with the substantially flat substrate; and means for tracing the at least one image on the front side of the two-sided transfer material. The means for tracing the at least one image includes applying pressure to each area of the at least one image being traced, wherein the applied pressure is sufficient to transfer material from the two-side transfer material onto the substantially flat substrate. A second general embodiment of this invention provides a kit for creating an image on a substrate. The kit includes at least one piece of two-sided transfer material, wherein each piece of the two-sided transfer material includes a front surface and a back surface. At least one thematic image has been created on the front side of the transfer material. The kit may include a tracing or outlining pen, paint, brushes, instructions, and numerous other items for facilitating the creation of a mural. A third general embodiment of this invention provides a method for transferring an image to a substrate. The method includes creating at least one line drawing on a front surface of a two-sided transfer sheet; placing the back surface of the two-sided transfer sheet on or against a substrate and affixing it thereto; tracing the line drawing on the front surface of the two-sided transfer sheet, wherein tracing the line drawing includes applying pressure to each area of the line drawing being traced, and wherein the applied pressure is sufficient to transfer material from the two-side transfer sheet onto the substrate; and removing the two-sided transfer sheet from the substrate to expose the image traced onto the substrate. The transferred image may be painted or otherwise colored to create a colorful mural having any variety of themes.

In an exemplary embodiment of this invention, a line drawing or image having a particular theme is created on the front side or surface of a two-sided, pressure sensitive, paper transfer sheet (Shanghai Chaohe Packaging & Printing Ltd., Co., Shanghai, China). The opposite side of the transfer sheet, i.e., the side that does not bear a line drawing or image includes a transferable media or material that leaves a visible mark on a substantially flat substrate, such as a wall, when pressure is applied to the front surface of the transfer sheet. Thus, by attaching or affixing the transfer sheet to a substrate using single or double-sided tape or other adhesive means and using pressure to trace over the line drawing, a visible outline for creating an image for painting or coloring can be created on the substrate. Various known materials may be used for or integrated into the transfer sheet for the purpose of creating visible marks on the surface to be painted. In the exemplary embodiment, the line drawing that appears on the front of the transfer sheet also includes a “paint-by the numbers” numerical color-coding scheme that facilitates the creation of an attractive mural that is similar in appearance to one or more examples that may be provided with the transfer sheet.

The mural template and kit of the present invention may be used according to the following exemplary method. The first general step involves tracing the line drawing or design appearing on the front surface of the template. The template (i.e., transfer sheet or “tracing panel”) is spread out on a floor, table or large countertop so that the entire template may be easily visualized. The template is then placed on the substrate and leveled or oriented relative thereto. A tape measure or other measuring means and a leveling reference line, typically provided on the front surface of the template, are useful for this purpose. The template is then flattened as completely as possible against the substrate and affixed thereto, using tape or other adhesive means. The line drawing and paint color reference numbers are then traced over using a tracing or outline pen and an image of the line drawing on the template is transferred to the substrate. The second general step is painting the mural. The template is then removed from the substrate and a painting guide provided with the kit is taped to the wall adjacent to the transferred image. A magic marker, paint pen, or the like is used to darken outlines appearing in the image. Once the outlines have dried, the sections of the transferred image are painted according to the painting guide and allowed to dry. The third general step involves touch-up. After the main painted areas have dried, the mural is inspected for any insufficiencies, and touch-ups of the painted areas are performed, if necessary.

Themes for the line drawings of the present invention may include religion, sports, nursery rhymes, children's stories, animals, or any other of a variety of possible themes and/or combinations of themes suitable and appropriate for children, adolescents, and adults. Exemplary mural designs may be given intriguing and memorable names such as: Noah's Friends, Proud Patriot, Counting Sheep, Barnyard Critters, Hard Hat Zone, Princess Palace, and a sports theme. Numerous other designs and themes are possible.

While the image-bearing transfer sheet may be sold as a stand-alone product, one embodiment of the present invention provides a complete mural painting kit that includes a container, at least one template/transfer sheet, a series of numbered bottles of paint in a variety of colors, brushes, a drop cloth, a divided tray for holding multiple volumes of paint (i.e., a palette), an outlining or tracing pen, a painting guide, and a set of instructions. Other materials and items may be included in the kit. Different kits with different combinations of images and materials or additional supplies and materials may also be provided.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A system for transferring an image to a substrate, comprising:
(a) a substantially flat substrate;
(b) a two-sided transfer material having a front side and a back side;
(c) at least one image created on the front side of the two-sided transfer material;
(d) means for contacting the back side of the two-sided transfer material with the substantially flat substrate; and
(e) means for tracing the at least one image on the front side of the two-sided transfer material, wherein the means for tracing the at least one image includes applying pressure to each area of the at least one image being traced, and wherein the applied pressure is sufficient to transfer material from the two-side transfer material onto the substantially flat substrate.

2. The system of claim 1, further comprising at least one volume of paint for painting the image transferred onto the substrate.

3. The system of claim 1, wherein the substantially flat surface is a wall, ceiling, or floor.

4. The system of claim 1, wherein the at least one image further includes at least one children's theme.

5. The system of claim 1, wherein the means for contacting the backside of the two-sided transfer material with the substantially flat substrate further includes single or double-sided tape.

6. A kit for creating an image on a substrate, comprising at least one piece of two-sided transfer material, wherein each piece of the two-sided transfer material includes a front surface and a back surface, and wherein at least one image has been created on the front side of the transfer material.

7. The kit of claim 6, further comprising at least one volume of paint.

8. The kit of claim 6, further comprising means for affixing the at least one piece of two-sided transfer material to a substrate.

9. The kit of claim 6, further comprising means for tracing the at least one image on the front surface of the two-sided transfer material.

10. The kit of claim 6, further comprising: instructions; at least one brush; a drop cloth; a painting guide, an outlining pen, a paint palette, and a container for the contents of the kit.

11. The kit of claim 6, wherein the at least one image further includes at least one children's theme.

12. A method for transferring at least one image to a substrate, comprising:
(a) creating at least one line drawing on a front surface of a two-sided transfer sheet;
(b) placing the back surface of the two-sided transfer sheet against a substrate;
(c) tracing the at least one line drawing on the front surface of the two-sided transfer sheet, wherein tracing the at least one line drawing includes applying pressure to each area of the at least one line drawing being traced, and wherein the applied pressure is sufficient to transfer material from the two-side transfer sheet onto the substrate; and
(d) removing the two-sided transfer sheet from the substrate to expose the image traced onto the substrate.

13. The method of claim 12, further comprising adding numbers to the line drawing, wherein the numbers correspond to a coloring guide for the transferred image.

14. The method of claim 12, further comprising using a leveling reference provided on the front surface of the transfer sheet to level the transfer sheet relative to the substrate.

15. The method of claim 12, further comprising painting or otherwise coloring the image traced onto the substrate.

16. The method of claim 12, wherein the line drawing further includes at least one children's theme or at least one adolescent theme.

17. The method of claim 12, wherein the line drawing further includes at least one sports theme.

18. The method of claim 12, wherein the two-sided transfer sheet is paper.

19. The method of claim 12, wherein placing the back side of the two-sided transfer sheet against a substrate further includes using tape or other adhesive to secure the two-sided transfer sheet to the substrate.

20. The method of claim 12, wherein the substrate is a wall, ceiling, or floor.
